(19) United States
(12) Patent Application Publication
(10) Pub. No.: US 2015/0358374 A1
(43) Pub. Date: Dec. 10, 2015

(54) Method of Data Transmission in Multicast or Broadcast Service

(71) Applicant: Acer Incorporated, New Taipei City (TW)

(72) Inventors: Hung-Yu Wei, New Taipei City (TW); Ching-Chun Chou, New Taipei City (TW)

(21) Appl. No.: 14/711,750

(22) Filed: May 13, 2015

Related U.S. Application Data
(60) Provisional application No. 62/007,423, filed on Jun. 4, 2014.

(51) Int. Cl. H04L 29/06; H04W 4/20

(52) U.S. Cl. CPC H04L 65/4076; H04L 65/60; H04W 4/20

(57) ABSTRACT

A method of data transmission in multicast or broadcast service, for a network in a wireless communication system is disclosed. The method comprises providing a multicast stream of the multicast or broadcast service to a mobile device of the wireless communication system, and transmitting an indication to the mobile device, wherein the indication is used for resource allocation of a data stream of the multicast or broadcast service.

### CROSS REFERENCE TO RELATED APPLICATIONS

This application claims the benefit of U.S. Provisional Application No. 62/007,423, filed on Jun. 4, 2014 and entitled “Hybrid MBMS Datacasting Design with Unicast Transmission”, the contents of which are incorporated herein in their entirety.

### BACKGROUND OF THE INVENTION

1. Field of the Invention

The present invention relates to a method used in a communication device in a wireless communication system, and more particularly, to a method of data transmission in multicast service.

2. Description of the Prior Art

Multicast-broadcast single-frequency network (MBSFN) is a communication channel defined in the Long Term Evolution (LTE) system. The transmission mode is intended as a further improvement of the efficiency of Multimedia Broadcast Multicast Service (MBMS), which can deliver services such as mobile TV using the LTE infrastructure, and is expected to compete with dedicated mobile/handheld TV broadcast systems such as Digital Video Broadcasting-Handheld (DVB-H) and Digital Video Broadcasting-Satellite services to Handhelds (DVB-SH). This enables network operators to offer mobile TV without the need for additional expensive licensed spectrum and without requiring new infrastructure and end-user devices.

In addition, 3GPP in Release 12 provides an enhanced MBMS operation, on-demand MBMS, for more flexibly and capability for 5G wireless communication. In detail, on-demand MBMS provides a mechanism to dynamically and seamlessly switch a unicast to a multicast one. If a unicast service is requested by a large amount of users, establishing numerous unicast to handle the request is a waste of radio resource. The mechanism of on-demand MBMS allows eNBs to switch unicast into multicast, for reducing the radio resource consumption. Please refer to FIG. 1, which illustrates a schematic diagram of MBMS content classifications. In FIG. 1, the MBMS content includes all kinds of information as part of the video frame. For example, a live basketball or baseball game may have scores, statistics and applications (i.e. paying/charging information or other interactive contents) displayed along with the live videos.

Thereafter, datacasting service, an enhanced feature of MBMS operation is defined and aims to provide MBMS data beyond the traditional MBMS content. Please refer to FIG. 2, which illustrates a schematic diagram of a MBMS transmission with file delivery over unidirectional transport (FLUTE) according to the prior art. In detail, current LTE system applies the FLUTE operation with video streams (i.e. MBMS1 shown in FIG. 2) and datacasting service (i.e. APP1, APP2, DC1 and DC2 shown in FIG. 2) encapsulated as a whole FLUTE session, being transmitted over a MAC entity with the same redundancy configuration. That is, the live video MBMS1, data APP1, video player App2, scores DC1, and statistics DC2 are transmitted by multicast within a MBMS session. As can be seen, based on the current FLUTE operation, the data APP1, video player App2, scores DC1 and statistics DC2 are conventionally distributed as part of the live video MBMS1. In other words, the data APP1, video player App2, scores DC1 and statistics DC2 are treated as figures, not formatted data, and encoded into video frames, which may cause overhead. Besides, the data APP1, video player App2, scores DC1 and statistics DC2 are normally non-real time contents and may not require frequently updated as real-time contents (i.e. the live video MBMS1). As a result, transmission of traditional MBMS content including both real-time and non-real-time contents results in low radio resource utilization.

Moreover, there are some multimedia services provide TV or digital contents over channels and interactions between users to provide customized services. For example, interactive television, raised by Interactive Television Alliance, it is a media convergence to add data services to TV technology. Interactive TV applications can be delivered over the broadcast channel, together with audio and video streams. These applications can be for example information services, games, interactive voting, e-mail, SMS or shopping. In addition, interactive TV application includes several user interactions with the program:

1. Interactivity with TV set: not changing video contents, like forwarding, rewinding, recoding, etc.

2. Interactivity with TV program contents: interact with video contents, like voting for the ending for a specific program.

3. Interactivity with TV-related contents: like television commerce.

Interactivity with TV-related contents is categorized as one-screen or two-screen interaction. One-screen interaction is to provide the service over the same television screen of the video. Such interaction is provided by TV set-up box, and includes advertisement, weather, sports, etc. For two-screen interactions, these services are provided through web broadcasting to computer, which is a different screen from the television. However, no video contents are distilled in such interactivity. The services are in parallel with the video, which may be not related to the video content.

For another multimedia service, like Digital Video Broadcasting-Multimedia Home Platform (DVB-MHP) defines broadcast framework to provide multimedia contents to users. It also includes links between internet services and broadcast services. For example, enhanced broadcasting combines digital broadcast of audio/video services with downloaded applications which can enable local interactivity. Interactive Broadcasting enables a range of interactive services associated or independent from broadcast services. Internet Access is intended for the provisioning of Internet services.

Please refer to FIG. 3, which illustrates application areas of enhanced broadcasting, interactive broadcasting and internet access and levels of profiles. In FIG. 3, different contents, including broadcast itself and interactive/network contents, are delivered through profiles and integrated as video graphics to the users. In addition, please refer to FIG. 4, which illustrates graphics models for display. As shown in FIG. 4, the essence of DVB-MHP is to integrate the contents from different profiles to generate different plane, and these planes are view by the viewers on the terminal screen. The DVB-MHP provides an integrated service to the users.

### SUMMARY OF THE INVENTION

It is there for an objective to provide a method of data transmission in multicast or broadcast service to solve the above problem.

The present invention discloses a method of data transmission in multicast or broadcast service, for a network in a wireless communication system. The method comprises providing a multicast stream to a mobile device of the wireless communication system, and transmitting an indication to the mobile device, wherein the indication is used for resource allocation of a data stream corresponding to the multicast stream.

The present invention further discloses a method of data transmission in multicast or broadcast service, for a mobile device in a wireless communication system. The method comprises receiving a multicast stream from a network of the wireless communication system, and receiving an indication for resource allocation of a data stream corresponding to the multicast stream, from the network, and receiving the data stream according to the resource allocation indicated by the indication.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of MBMS content classifications.

FIG. 2 illustrates a schematic diagram of MBMS transmission according to the prior art.

FIG. 3 illustrates application areas of enhanced broadcasting, interactive broadcasting and internet access and levels of profiles.

FIG. 4 illustrates graphics models for display.

FIG. 5 illustrates a schematic diagram of a MBSFN deployment.

FIG. 6 illustrates a schematic diagram of an exemplary communication device.

FIG. 7 is a flowchart of an exemplary process according to the present disclosure.

FIG. 8 illustrates a schematic diagram of an exemplary MBMS content transmission.

FIGS. 9A-9D illustrates a schematic diagram of a location of a pointer.

FIGS. 10A-11B illustrates a schematic diagram of resource allocation for an indication/pointer.

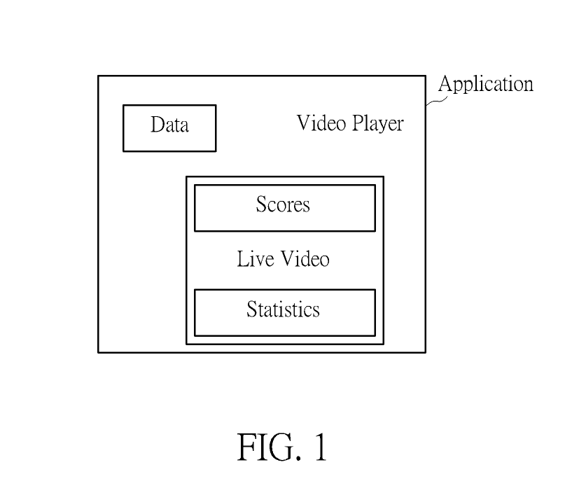

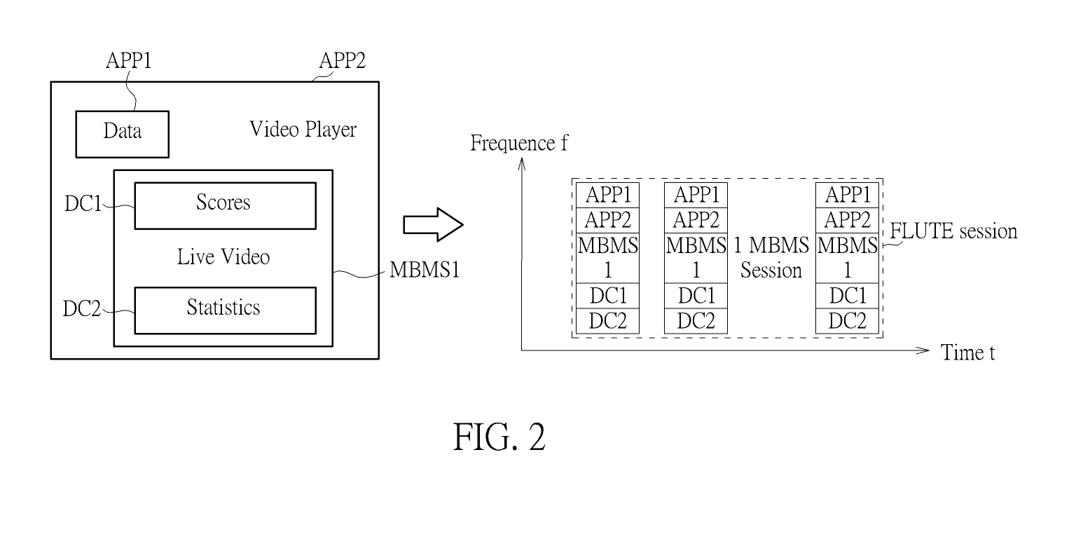

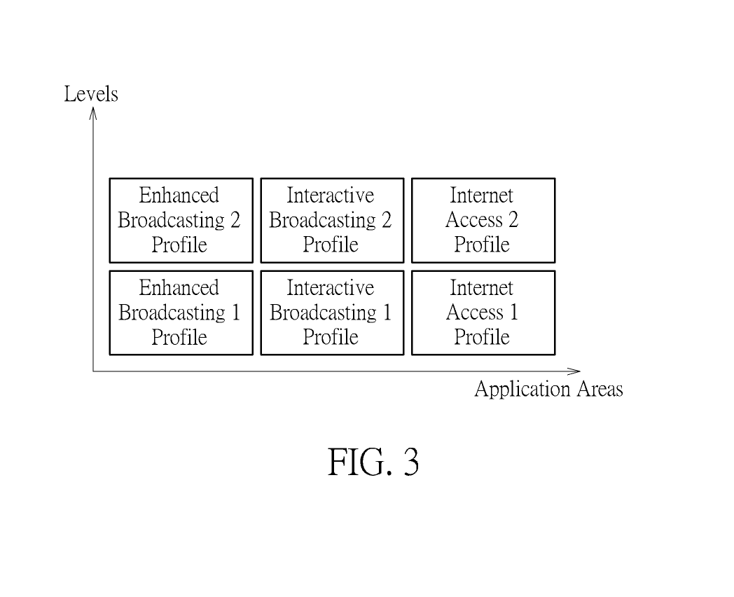

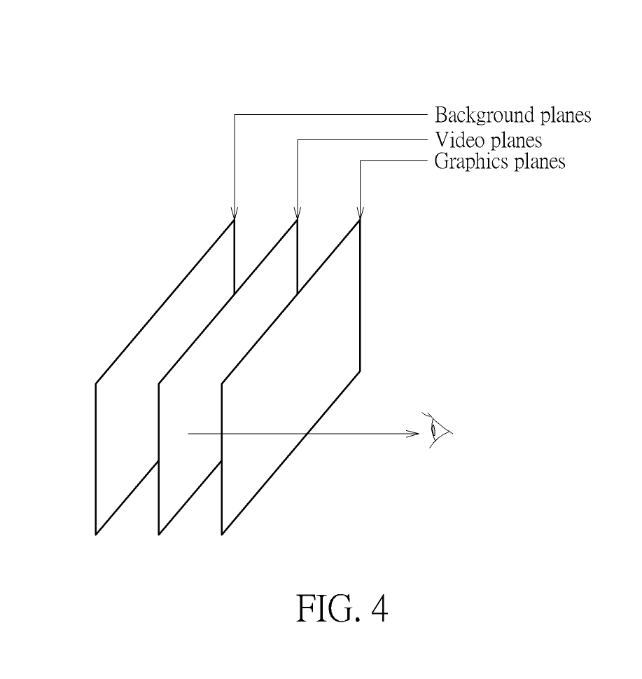

### DETAILED DESCRIPTION

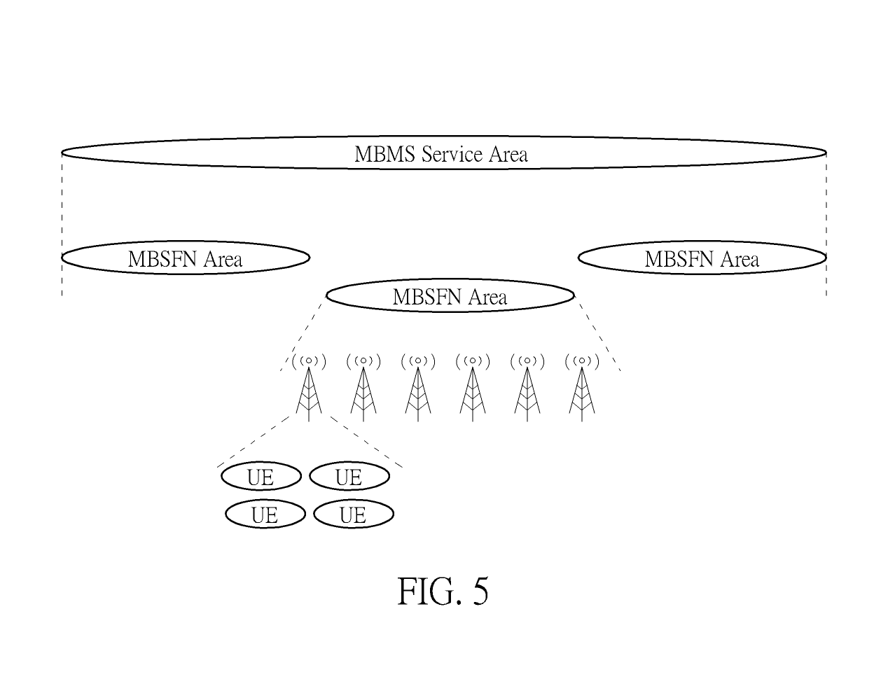

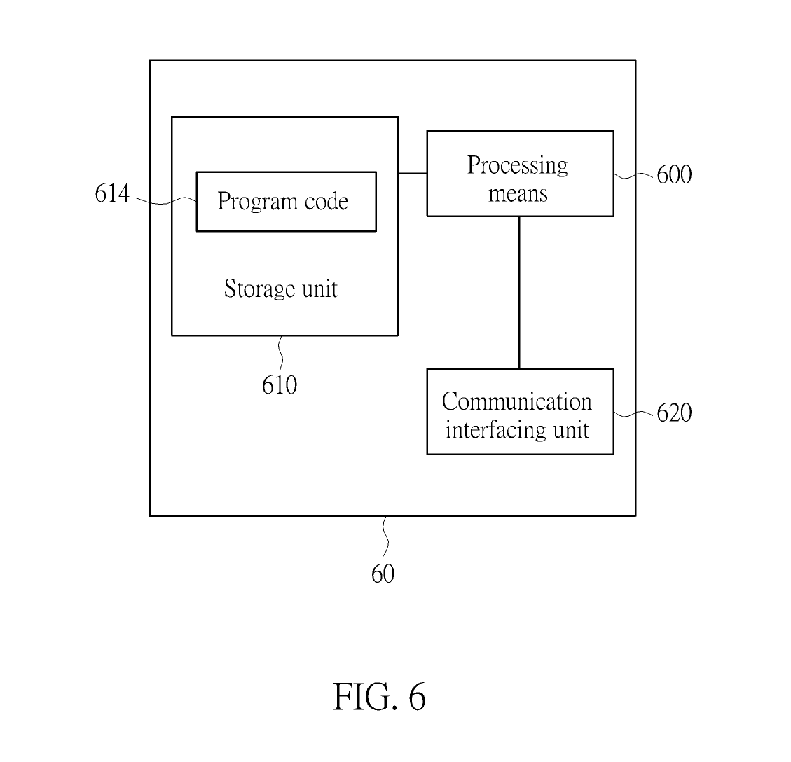

FIG. 5 illustrates a schematic diagram of a multicast-Broadcast Single Frequency Network (MBSFN) deployment in the LTE system. LTE specification supports for Multimedia Broadcast Multicast Service (MBMS), which is a multimedia service performed by MBSFN. In detail, MBMS is a point-to-multipoint service in which data is transmitted from a single source entity to multiple recipients. Transmitting the same data to multiple recipients allows network resources to be shared. In FIG. 5, the MBSFN Synchronization area is capable of supporting one or more MBSFN area and the MBSFN area is an area which consists of a group of cells within an MBSFN Synchronization Area. An MBSFN transmission from multiple cells within the MBSFN Area is seen as a single transmission by a UE. Overall concept for MBSFN transmission is as follows. An eNB can transmit the same data (i.e. MBMS) to multiple UEs simultaneously.

FIG. 6 illustrates a schematic diagram of an exemplary communication device 60. The communication device 60 can be the UE or eNB shown in FIG. 5. The communication device 60 may include a processing means 600 such as a microprocessor or Application Specific Integrated Circuit (ASIC), a storage unit 610 and a communication interfacing unit 620. The storage unit 610 may be any data storage device that can store program code 614, for access by the processing means 600. Examples of the storage unit 610 include but are not limited to a subscriber identity module (SIM), read-only memory (ROM), flash memory, random-access memory (RAM), CD-ROMs, magnetic tape, hard disk, and optical data storage device. The communication interfacing unit 620 is preferably a radio transceiver and can exchange wireless signals with a network (i.e. E-UTRAN) according to processing results of the processing means 600.

In order to satisfy the next generation wireless multicast requirement, the applicant considers the case of MBMS contents distribution, in view of datacasting service.

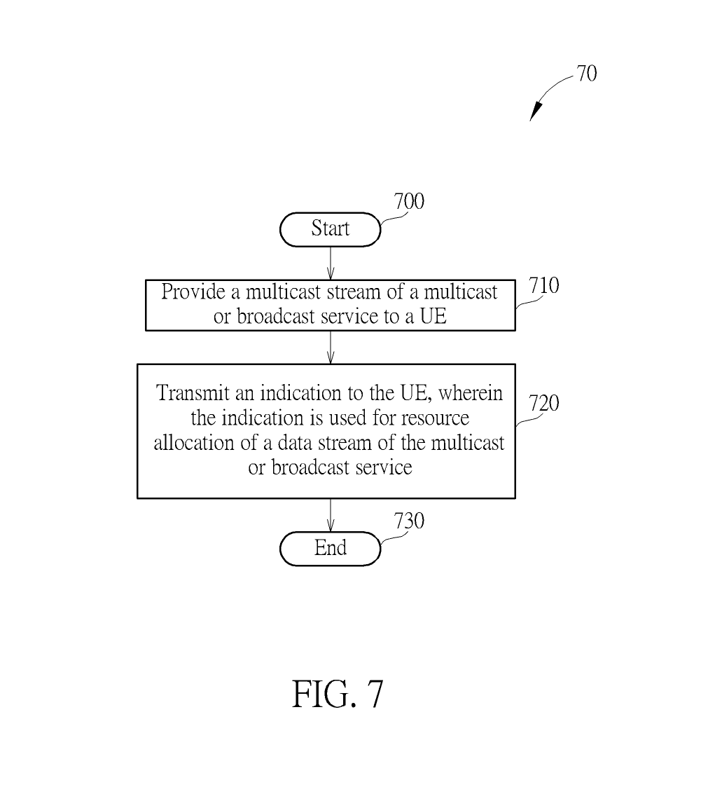

Please refer to FIG. 7, which is a flowchart of a process 70 according to an example of the present disclosure. The process 70 is utilized in the communication device 60 (i.e. the eNB in FIG. 5) for data transmission in multicast or broadcast service. The process 70 may be compiled into a program code 614 to be stored in the storage unit 610, and may include the following steps:

Step 700: Start.

Step 710: Provide a multicast stream of a multicast or broadcast service to a UE.

Step 720: Transmit an indication to the UE, wherein the indication is used for resource allocation of a data stream of the multicast or broadcast service.

Step 730: End.

According to the process 70, the eNB provides multicast stream to the UE and provides a signal (i.e. an indication or a pointer) to inform the UE of a data stream existence. Therefore, the UE can locate and receive the data stream by the indication or pointer. As a result, the eNB can transmit the data stream separated from the multicast stream. In addition, the eNB allows to transmit the data stream by unicast or multicast or to switch between unicast and multicast.

In a word, the process 70 proposes a datacasting method for MBMS operation of the LTE system. In detail, the process 70 distills MBMS data of datacasting service from the MBMS video with resource allocation indication. However, the process 70 may be not limited in MBMS operation of the LTE system, but can be used for other multimedia service with datacasting.

In an embodiment, an user service description (USD) may be also delivered by using the abovementioned datacasting design because the information within the USD is non-real-time contents. The USD includes MBMS session information. Users may need this information to check if contents of the MBMS sessions are desired. Content schedule information is also stored in USD.

In an embodiment, a MBMS video may be encrypted to prevent other users to eavesdrop a charged MBMS session. On the other hand, a MBMS data may be a preview for the MBMS video, which is not encrypted and is transmitted by multicast. Thus, free users may still watch the video preview. After the users pay for the MBMS video, decoding keys may be delivered to the user by unicast. Other private information, including registration, authentication, charging, etc., may also be delivered by the proposed datacasting design (i.e. by multicast, unicast, or hybrid).

In an embodiment, the proposed datacasting design is applied for software updates. In detail, application software enables the user to receive MBMS contents in the form of audio/video/some kind of multimedia (i.e. a MBMS video). The software may require updates to add new features or fix the bug. For example, a movie may be encoded by a special code, and the decoder was not included in the application software. In this case, a MBMS data of datacasting service includes code updates and is transmitted by multicast, unicast, or hybrid. Therefore, users whose application software does not have the decoder may access the code updates. Similarly, the communication software of a company may require certain bug fix. However, different versions of the software have different bugs, thus requiring different patches. With the proposed datacasting method, MBMS data includes patches for version-specific bugs, and is transmitted to users by multicast, unicast, or hybrid. As can be seen, the proposed datacasting method can be used for customized interface or special services for the users.

In other embodiment, the datacasting design is applied for program preview. Users should be able to skim through some rough sketch to determine the desired contents. For example, one baseball game may have multiple viewing angles from different cameras. Users may wish to switch from these cameras in a fast and convenient manner to determine the desired viewing angle. Thus, the MBMS video includes baseball game and the MBMS data of the datacasting service includes preview/snapshots of other videos. The MBMS data of the datacasting service may be transmitted by multicast, unicast, or hybrid according to the demand (i.e. asking for a special angle/view for the baseball game) of the user.

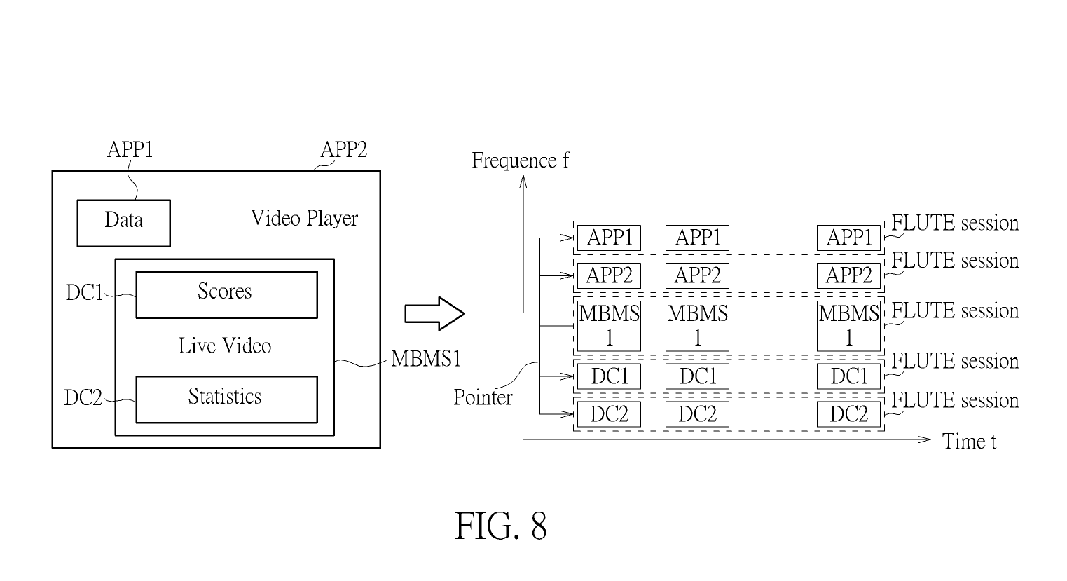

Please refer to FIG. 8, which illustrates a schematic diagram of an exemplary MBMS content transmission. In FIG. 8, the live video MBMS1 is transmitted by multicast, whereas data APP1, video player APP2, scores DC1 and statistics DC2 may be transmitted by unicast unicast or hybrid. This is realized by the indication or the pointer to indicate the resource allocation of the data APP1, video player APP2, scores DC1, statistics DC2. Besides, as shown in FIG. 8, the MBMS content is provided with multiple streams, including a main-stream (i.e. the live video MBMS1), and several sub-streams (i.e. the data APP1, video player APP2, scores DC1 and statistics DC2). The eNB transmits main-stream with multicast and transmits sub-streams with multicast, unicast or hybrid.

For realization of providing MBMS content over multiple streams, the applicant proposes a FLUTE operation. As shown in FIG. 8, the live video MBMS1, data APP1, video player APP2, scores DC1 and statistics DC2 are encapsulated into different FLUTE sessions. As a result, video streams (i.e. MBMS1 shown in FIG. 8) and datacasting service (i.e. APP1, APP2, DC1 and DC2 shown in FIG. 8) are transmitted over a MAC entity with different redundancy configuration. In other words, the MAC layer takes the live video MBMS1, data APP1, video player APP2, scores DC1 and statistics DC2 as different FLUTE objects. Therefore, the MAC layer could allocate dedicated MAC resource for each FLUTE object. As a consequence, the MBMS video (i.e. the live video MBMS1) and MBMS data (i.e. the data APP1, video player APP2, scores DC1 and statistics DC2) are transmitted over different MAC radio resource. On the other hand, when the UE receives the MAC layer packets and reconstructed the FLUTE objects, it may restore the MBMS video and MBMS data.

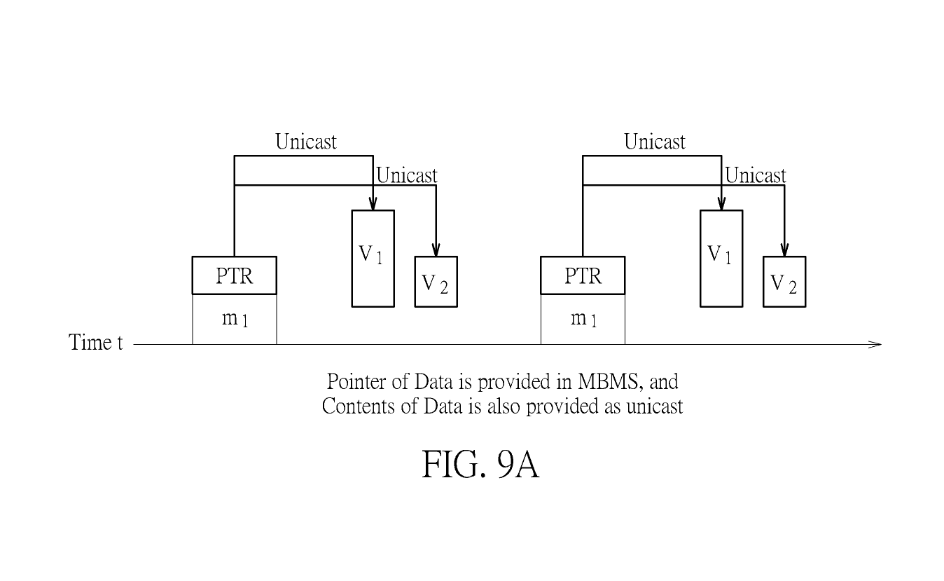

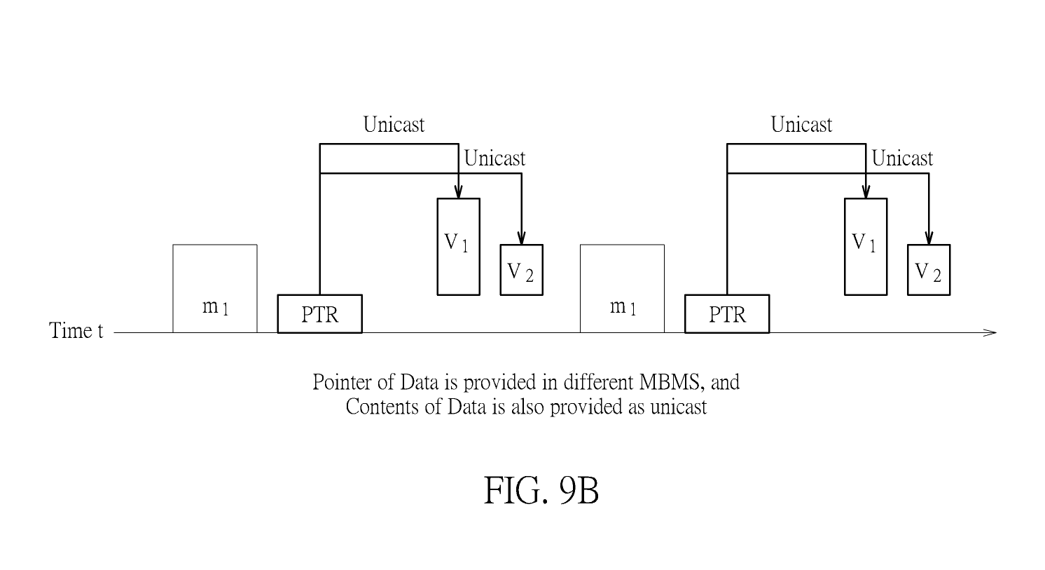

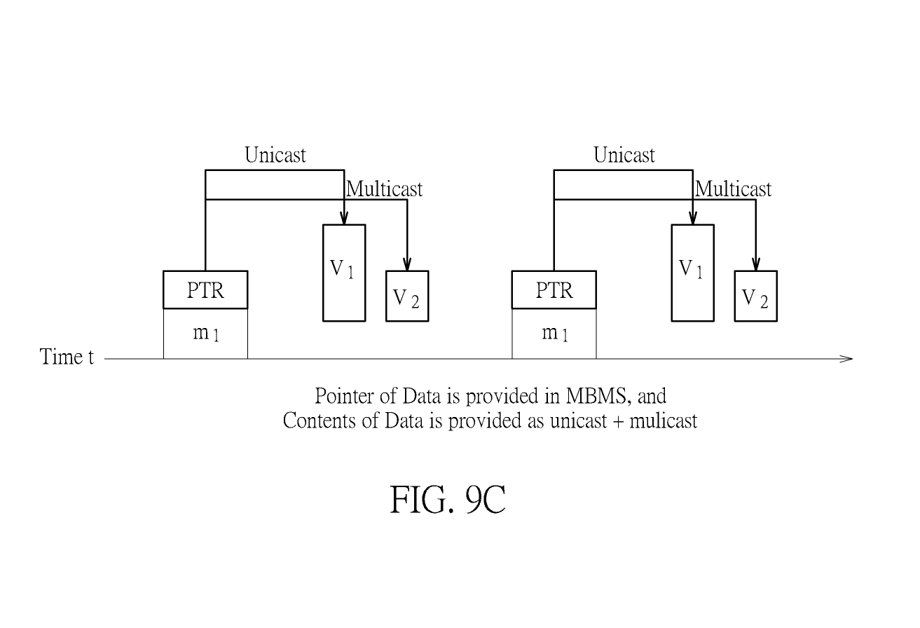

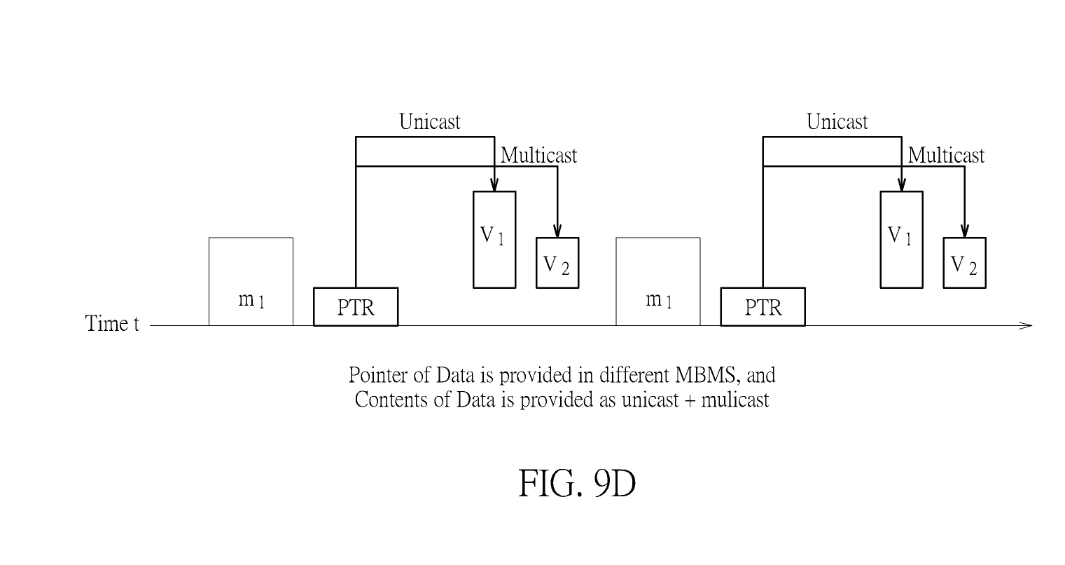

Note that, by means of an indication or a pointer for indicating resource allocation of MBMS data of datacasting service, the MBMS data of datacasting service is distilled from MBMS video. The indication or pointer may be located along with the MBMS video or separated signaling. Please refer to FIG. 9A, which illustrates a schematic diagram of a location of a pointer PTR. In FIG. 9A, the pointer PTR is provided in a live video m1 to indicate a resource allocation of data V1-V2, where the data V1-V2 is provided as unicast. In FIG. 9B, the pointer PTR is not provided in the live video m1, but in a dedicated resource or different live video to indicate a resource allocation of data V1-V2, where the data V1-V2 is provided as unicast. In FIG. 9C, the pointer PTR is provided in the live video m1 to indicate a resource allocation of the data V1-V2, where the data V1 is provided as unicast and the data V2 is provided as multicast (namely hybrid scheme). In FIG. 9D, the pointer PTR is not provided in the live video m1, but in a dedicated resource or different live video to indicate a resource allocation of data V1-V2, where the data V1 is provided as unicast and the data V2 is provided as multicast (namely hybrid scheme).

With hybrid scheme for datacasting service, the present invention can provide customized data service based on user's requirements and interests. For example, a baseball game with the schedule of the other games, scores, game statistics, and team/athletes information. In addition, if a large number of users requesting for specific MBMS data service, the present invention can provide the data over multicast which is better than unicast in view of radio resource. On the other hand, unicast for datacasting service with less requirements.

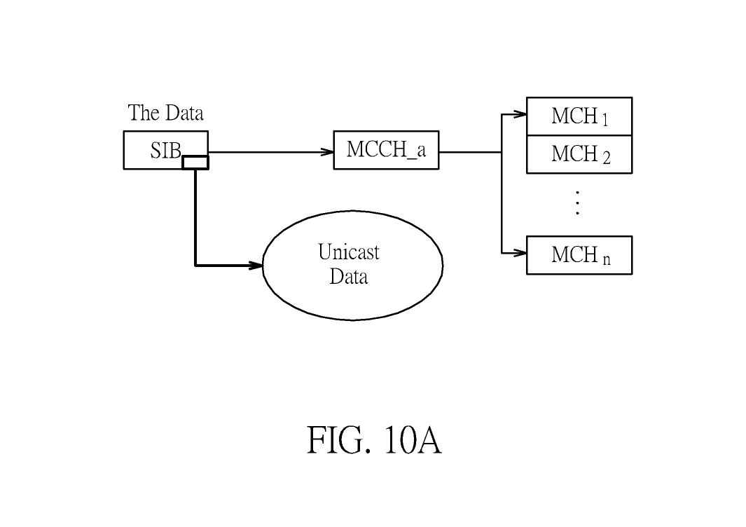

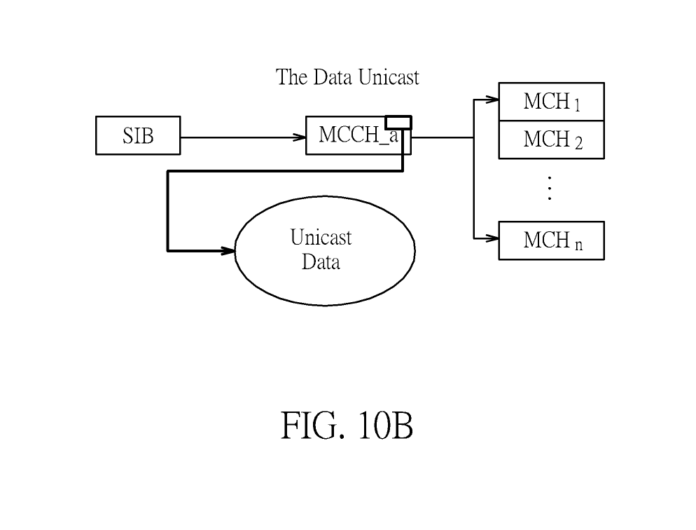

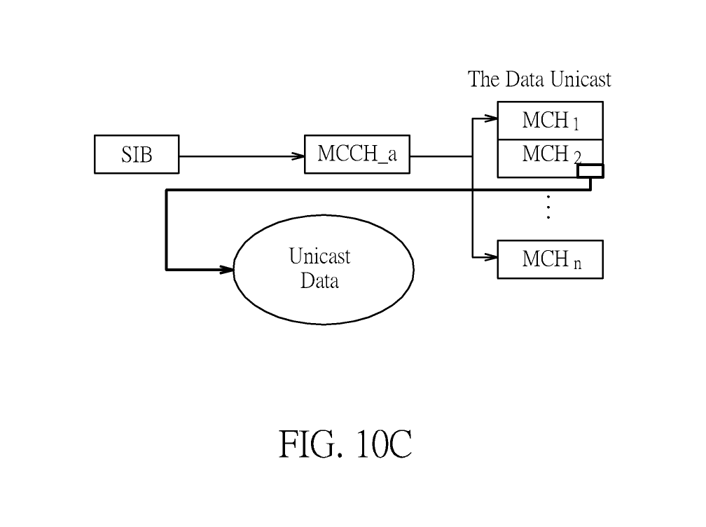

In addition, the indication or the pointer may be provided in system information block 13 (SIB13), MBMS control channel (MCCH) or MBMS data channel (MCH). The indication/pointer may indicate location of resource blocks, subframes, carriers, etc. Or, the indication/pointer may be provided in forms of server IP, URL, data object identifier (DOI). Please refer to FIGS. 10A-10C, which illustrates a schematic diagram of resource allocation for the indication/pointer. In FIG. 10A, the indication/pointer is provided in SIB13, and MBMS data for MBMS data is provided as unicast. In FIG. 10B, the indication/pointer is provided in MCCH, and MBMS data is provided as unicast. In FIG. 10C, the indication/pointer is provided in MCH, and MBMS data is provided as unicast

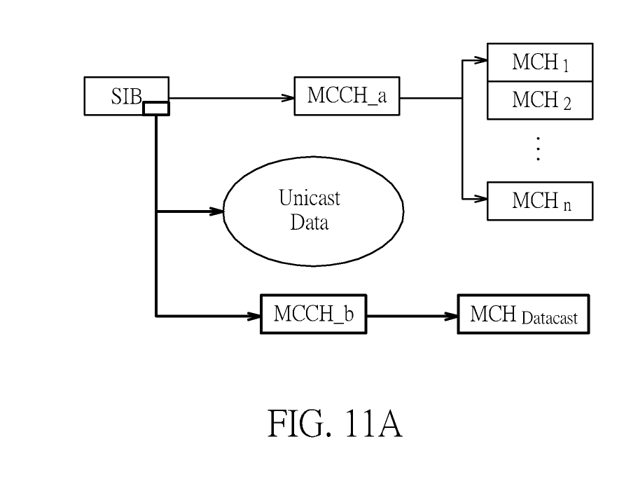

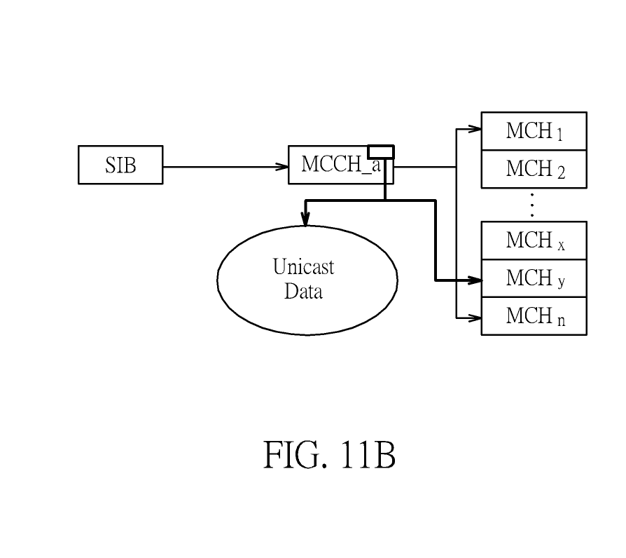

In other embodiment, please refer to FIGS. 11A-11B. In FIG. 11A, the indication/pointer is provided in SIB13, and the MBMS data for the MBMS video in MCCH_a is provided as unicast and multicast (i.e. allocated in MCCH_b). Thus, users may access the desired information from the multicast data (i.e. in MCCH_b or unicast). In FIG. 11B, the indication/pointer is provided in MCCH, and the MBMS data for MBMS video in MCHx is provided as unicast and multicast (i.e. allocated in MCHy). Thus, users may access the desired information from the multicast data (i.e. in MCHy or unicast).

Note that, the indication/pointer may include the configuration of a period of the indication/pointer, resource allocation for the MBMS data, the type of the indication/pointer, data rate, and forward error correction (FEC) redundancy level, which is depended on the importance of MBMS data, data reliability, charging, user priority, etc.

The abovementioned data transmission method is able to provide dynamic configurability that better serve wireless devices based n diverse QoS, preference, locations, and other factors. As to the dynamic configurability, the radio resource utilization and user satisfaction might be improved. The proposal benefits from three points of view: SFN's coverage, adaptive redundancy, and QoS requirements. The coverage of MBMS data depends on user's interests and distribution, so the coverage of MBMS data may not be identical to the coverage of MBMS video. For example, the viewers of one baseball game may reside in different states of a country. They may be interested in different games due to geographical constrains, and therefore they prefer different MBMS data stream. In addition, transmitting FLUTE objects over different MAC resource has higher flexibility and efficiency if we need precise SFN configuration. Besides, the redundancy level of a FLUTE payload is consistent within the packet. Serving the FLUTE session over different MAC unicast or multicast allows for different FEC configuration. Moreover, the QoS requirements also impose extra overhead because MBMS video and MBMS data varies in QoS requirements and characteristic, if we integrate all these stream into one MBMS session, the QoS profile of the MBMS session should satisfy the requirements of all MBMS video and MBMS data. The MBMS session should be delay-sensitive for real-time contents.

The abovementioned steps of the processes including suggested steps can be realized by means that could be a hardware, a firmware known as a combination of a hardware device and computer instructions and data that reside as read-only software on the hardware device or an electronic system. Examples of hardware can include analog, digital and mixed circuits known as microcircuit, microchip, or silicon chip. Examples of the electronic system can include a system on chip (SOC), system in package (SiP), a computer on module (COM) and the communication device 60.

In conclusion, the present invention provides a data transmission method for multicast/broadcast multimedia service, to dynamically and seamlessly switch data transmission between unicast and multicast. In detail, the present invention proposes a signaling mechanism (i.e. an indication/pointer) to provide the resource allocation of data, so as to distill data from video.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of data transmission in multicast or broadcast service for a network in a wireless communication system, comprising:
providing a multicast stream of the multicast or broadcast service to a mobile device of the wireless communication system; and
transmitting an indication to the mobile device, wherein the indication is used for resource allocation of a data stream of the multicast or broadcast service.

2. The method of claim 1, wherein the indication is provided within the multicast stream or a dedicated resource.

3. The method of claim 1, wherein the indication is a pointer residing in a system information block (SIB), a MBMS control channel (MCCH) or MBMS data channel (MCH).

4. The method of claim 1, wherein the data stream is real-time contents or non-real time contents.

5. The method of claim 1, further comprising:
transmitting the multicast stream to the mobile device via a multicast mode; and
transmitting the data stream to the mobile device via the multicast and/or a unicast mode.

6. The method of claim 1, further comprising:
including a data configuration in the multicast stream, wherein the data configuration includes at least one of an indication setting, an indication type, a period of updating the indication, a data rate and a forward error correction (FEC) redundancy level.

7. The method of claim 1, further comprising:
updating the indication when the network switches the data stream between a unicast mode and a multicast mode.

8. The method of claim 1, further comprising:
determining to transmit the data stream via a unicast mode or multicast mode according to a demand from the mobile device.

9. A method of data transmission in multicast or broadcast service, for a mobile device in a wireless communication system, comprising:
receiving a multicast stream of the multicast or broadcast service from a network of the wireless communication system; and
receiving an indication for resource allocation of a data stream of the multicast or broadcast service, from the network; and
receiving the data stream according to the resource allocation indicated by the indication.

10. The method of claim 9, wherein receiving the indication for resource allocation of the data stream of the multicast or broadcast service, from the network comprises:
receiving the indication in the multicast stream or a dedicated resource assigned by the network; or
receiving the indication in a system information block (SIB), a MBMS control channel (MCCH) or MBMS data channel (MCH).

11. The method of claim 9, wherein receiving the data stream according to the resource allocation indicated by the indication comprises:
receiving the data stream via the multicast and/or a unicast mode.

12. The method of claim 9, further comprising:
receiving a data configuration in the multicast stream, wherein the data configuration includes at least one of an indication setting, an indication type, a period of updating the indication, a data rate and a forward error correction (FEC) redundancy level.
